(19) United States
(12) Patent Application Publication
(10) Pub. No.: US 2014/0108274 A1
(43) Pub. Date: Apr. 17, 2014

(54) System and Method for Legal Order Processing

(71) Applicant: BANK OF AMERICA CORPORATION, Charlotte, NC (US)

(72) Inventors: Timothy Charles Sherfey, Carrollton, TX (US); Shellie Jean Sadr, Bellevue, WA (US); Jack Meyers, Clayton, CA (US); Kristopher John Krogulecki, Mechanicsville, VA (US); Cynthia Suzanne Carney, Phoenix, AZ (US)

(73) Assignee: Bank of America Corporation, Charlotte, NC (US)

(21) Appl. No.: 13/652,006

(22) Filed: Oct. 15, 2012

(51) Int. Cl. G06Q 50/18

(52) U.S. Cl. 705/311

(57) ABSTRACT

A system includes a memory and a processor communicatively coupled to the memory. The memory stores a plurality of legal orders. Each legal order is associated with a request by an entity submitted using a standardized legal order form. The processor is operable to access a particular legal order stored in the memory, determine, from a plurality of categories, a category of the particular legal order, process the particular legal order based on the determined category, and transmit a legal order response for receipt by the entity. The plurality of categories includes a subpoena for information and an attachment associated with an amount of funds.

### TECHNICAL FIELD OF THE INVENTION

The present invention relates generally to legal orders and more specifically to a system and method for legal order processing.

### BACKGROUND OF THE INVENTION

Many institutions receive legal orders from various entities and agencies. As one example, a financial institution may receive a legal order from a government agency to levy funds from a particular account. As another example, an institution may receive a legal order from an agency related to a subpoena for certain documents. Typically, legal orders are not in a standardized format and thus processing of legal orders is an inefficient and time-intensive operation.

### SUMMARY OF THE INVENTION

In accordance with the present disclosure, the disadvantages and problems associated with prior legal order processing have been substantially reduced or eliminated.

According to one embodiment of the present invention, a system includes a memory and a processor communicatively coupled to the memory. The memory stores a plurality of legal orders. Each legal order is associated with a request by an entity submitted using a standardized legal order form. The processor is operable to access a particular legal order stored in the memory, determine, from a plurality of categories, a category of the particular legal order, process the particular legal order based on the determined category, and transmit a legal order response for receipt by the entity. The plurality of categories includes a subpoena for information and an attachment associated with an amount of funds.

Certain embodiments of the disclosure may provide one or more advantages. An advantage of one embodiment may be that multiple entities may utilize a standardized legal order form to submit legal orders to institutions. In some embodiments, legal orders may be processed accurately and efficiently by utilizing an external exchange hub to collect and distribute legal orders. In some embodiments, institutions may transmit legal order responses to entities using the external exchange hub.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its advantages, reference is now made to the following description taken in conjunction with the accompanying drawings, in which:

FIG. 1 illustrates a system for providing legal order processing, according to certain embodiments;

FIG. 2 illustrates an example standardized form that may be utilized by the system of FIG. 1 for legal order processing, according to certain embodiments; and

FIG. 3 illustrates a method for providing legal order processing, according to certain embodiments.

### DETAILED DESCRIPTION OF THE INVENTION

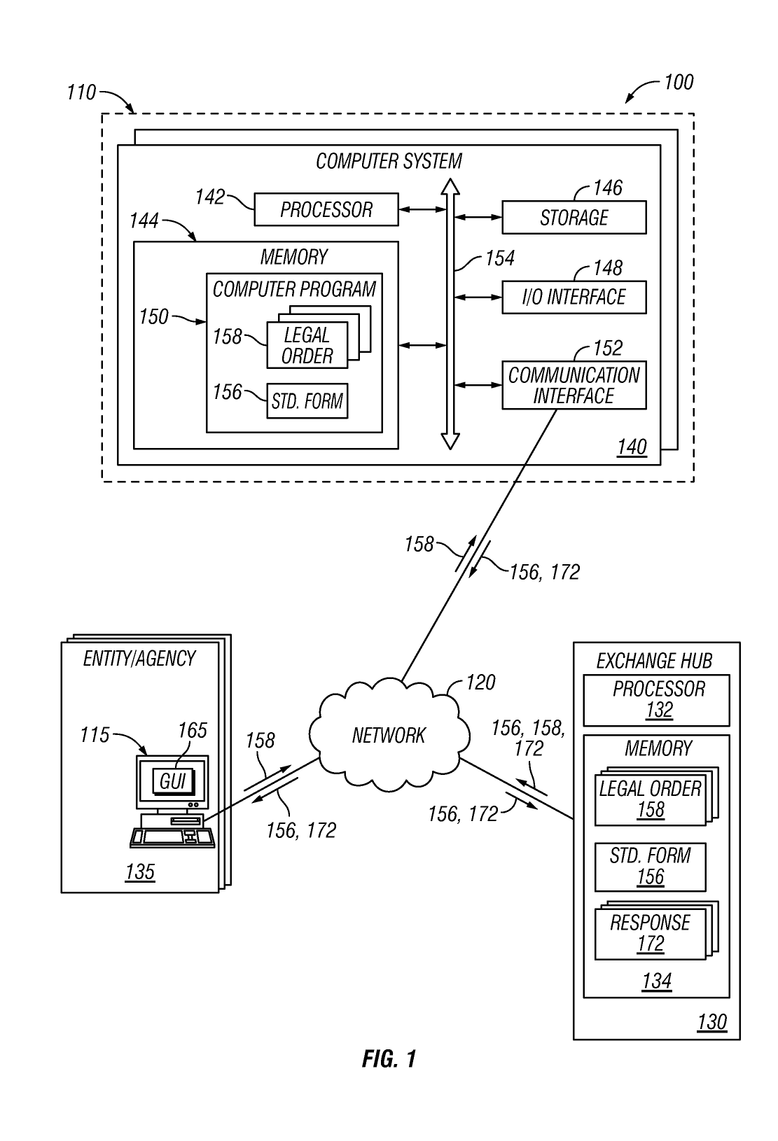

Embodiments of the present disclosure and its advantages are best understood by referring to FIGS. 1 through 3 of the drawings, like numerals being used for like and corresponding parts of the various drawings.

Banks and other institutions typically receive numerous legal orders from various agencies and entities. As one example, a financial institution may receive a legal order from a government agency to levy funds from a particular account held at the financial institution by a particular customer. As another example, an institution may receive a legal order from an agency related to a subpoena for certain documents. More specifically, an institution such as a bank may receive a subpoena from a court to provide information such as documents, video, and the like.

Typically, legal orders received at institutions such as banks are not in any particular format. For example, legal orders from a particular court may be in a different format than legal orders from a different government agency. As a result, the processing of legal orders is inefficient, slow, and prone to errors.

The teachings of the disclosure recognize that it would be desirable to provide legal order processing to institutions in a more efficient, accurate, and timely manner. FIGS. 1 through 3 below illustrate a method and system for legal order processing according to the teachings of the disclosure.

FIG. 1 illustrates a system 100 according to certain embodiments. System 100 may include an enterprise 110, one or more entities 135, and an exchange hub 130. Enterprise 110, entities 135, and exchange hub 130 may be communicatively coupled by a network 120. In some embodiments, entity 135 may be directly communicatively coupled to enterprise 110 and/or exchange hub 130, and enterprise 110 may be directly communicatively coupled to exchange hub 130. System 100 is generally operable to provide legal order processing as described below.

In general, one or more computer systems 140 of enterprise 110 provide processing of legal orders 158 from one or more entities 135. Entity 135 may first utilize client 115 to transmit one or more legal orders 158 to exchange hub 130 where they are stored in memory 134. Each legal order 158 is generated using a standard legal order form 156 provided by exchange hub 130 or enterprise 110. In some embodiments, entity 135 may utilize standard legal order form 156 to generate multiple legal orders 158 which are transmitted to exchange hub 130 in bulk. In other embodiments, entity 135 may view a graphical representation of standard legal order form 156 on graphical user interface (GUI) 165 of client 115, enter data into the GUI 165 to create a single legal order 158, and transmit the completed legal order 158 to exchange hub 130. After receiving one or more legal orders 158 from entity 135, legal orders 158 stored in memory 134 of exchange hub 130 may be transmitted to computer system 140 using either a push or pull transmission technique. Computer system 140 accesses legal orders 158 received from exchange hub 130, processes the legal orders 158 according to information in the legal orders 158, and transmits legal order responses 172 back to exchange hub 130. Exchange hub 130 stores legal order response 172 in memory 134 and transmits them to entities 135 using any available technique.

Client 115 may refer to any device that enables entity 135 to interact with exchange hub 130 and/or computer system 140. In some embodiments, client 115 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Client 115 may also comprise any suitable user interface, display, microphone, keyboard, or any other appropriate terminal equipment usable by entity 135. It will be understood that system 100 may comprise any number and combination of clients 115. Client 115 may be utilized by entity 135 to interact with exchange hub 130 and/or computer system 140 in order to transmit legal orders 158 and receive legal order responses 172, as described below.

In some embodiments, client 115 may include a graphical user interface (GUI) 165. GUI 165 is generally operable to tailor and filter data presented to entity 135, and to capture input data from entity 135. GUI 165 may comprise a plurality of displays having forms, interactive fields, pull-down lists, and buttons operated by user. GUI 165 may include multiple levels of abstraction including groupings and boundaries. It should be understood that the term GUI 165 may be used in the singular or in the plural to describe one or more GUIs 165 and each of the displays of a particular GUI 165.

In some embodiments, GUI 165 may be a web-based application that is provided by exchange hub 130 and/or computer system 140 over network 120 and displayed in any appropriate internet browser, including, but not limited to, Microsoft Internet Explorer, Mozilla Firefox, Google Chrome, Apple Safari, Opera, a browser of a smartphone, or any other appropriate browser. GUI 165 may include any number of input boxes and may be arranged in any appropriate configuration.

Entity 135 may refer to any agency, organization, institution, company, individual, or any other entity that may transmit legal orders 158. For example, entity 135 may refer to any government agency such as a federal agency (i.e., the Internal Revenue Service (IRS)), a state agency (i.e., a state tax board), a municipal agency (i.e., a city human resources administration), and the like. As another example, entity 135 may refer to any court such as a federal court, a state court, a municipal court, and the like. In some embodiments, entity 135 may refer to an individual such as an attorney, an investigator, a case worker, and the like.

Exchange hub 130 may refer to any intermediary system for collecting legal orders 158 from entities 135, transmitting legal orders 158 to one or more enterprises 110, collecting legal order responses 172 from enterprises 110, and distributing legal order responses 172 to entities 135. In certain embodiments, exchange hub 130 is capable of storing images, documents, and other data associated with a legal order 158 or legal order response 172. In some embodiments, exchange hub 130 may be separate from enterprise 110. In other embodiments, exchange hub 130 may be a part of enterprise 110, be operated by enterprise 110, or otherwise be associated with enterprise 110.

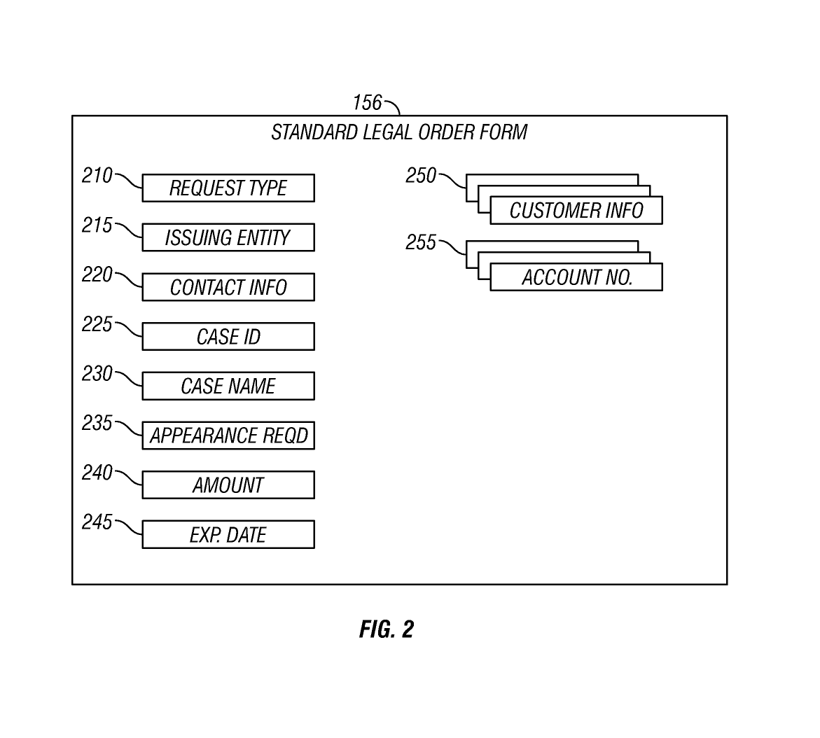

Exchange hub 130 may be any appropriate system such as a computer system 140 described below. In some embodiments, exchange hub 130 includes a processor 132 coupled to one or more memory devices 134. Processor 132 and memory 134 may be similar to processor 142 and memory 144, respectively, described in more detail below. Memory 134 may store legal orders 158, standard legal order form 156, and legal order responses 172. Legal orders 158, standard legal order form 156, and legal order responses 172 are described in more detail below. A particular embodiment of standard legal order form 156 is described in reference to FIG. 2 below.

In certain embodiments, network 120 may refer to any interconnecting system capable of transmitting audio, video, signals, data, messages, or any combination of the preceding. Network 120 may include all or a portion of a public switched telephone network, a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, enterprise 110 may refer to a financial institution such as a bank and may include one or more computer systems 140. Computer systems 140 perform one or more steps of one or more methods described or illustrated herein. In particular embodiments, one or more computer systems 140 provide functionality described or illustrated herein. In particular embodiments, software running on one or more computer systems 140 performs one or more steps of one or more methods described or illustrated herein or provides functionality described or illustrated herein. Particular embodiments include one or more portions of one or more computer systems 140.

This disclosure contemplates any suitable number of computer systems 140. This disclosure contemplates computer system 140 taking any suitable physical form. As example and not by way of limitation, computer system 140 may be a virtual machine (VM), an embedded computer system, a system-on-chip (SOC), a single-board computer system (SBC) (e.g., a computer-on-module (COM) or system-on-module (SOM)), a desktop computer system, a laptop or notebook computer system, an interactive kiosk, a mainframe, a mesh of computer systems, a server, an application server, or a combination of two or more of these. Where appropriate, computer system 140 may include one or more computer systems 140; be unitary or distributed; span multiple locations; span multiple machines; or reside in a cloud, which may include one or more cloud components in one or more networks. Where appropriate, one or more computer systems 140 may perform without substantial spatial or temporal limitation one or more steps of one or more methods described or illustrated herein. As an example and not by way of limitation, one or more computer systems 140 may perform in real time or in batch mode one or more steps of one or more methods described or illustrated herein. One or more computer systems 140 may perform at different times or at different locations one or more steps of one or more methods described or illustrated herein, where appropriate.

In some embodiments, computer system 140 may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, computer system 140 may be a web server running web server applications such as Apache, Microsoft's Internet Information Server™, and the like.

In particular embodiments, computer system 140 includes a processor 142, memory 144, storage device 146, an input/output (I/O) interface 148, a communication interface 152, and a bus 154. Although this disclosure describes and illustrates a particular computer system having a particular number of particular components in a particular arrangement, this disclosure contemplates any suitable computer system having any suitable number of any suitable components in any suitable arrangement.

In particular embodiments, processor 142 includes hardware for executing instructions, such as those making up a computer program 150. As an example and not by way of limitation, to execute instructions, processor 142 may retrieve (or fetch) the instructions from an internal register, an internal cache, memory 144, or storage device 146; decode and execute the instructions; and then write one or more results to an internal register, an internal cache, memory 144, or storage device 146. In particular embodiments, processor 142 may include one or more internal caches for data, instructions, or addresses. This disclosure contemplates processor 142 including any suitable number of any suitable internal caches, where appropriate. As an example and not by way of limitation, processor 142 may include one or more instruction caches, one or more data caches, and one or more translation lookaside buffers (TLBs). Instructions in the instruction caches may be copies of instructions in memory 144 or storage device 146, and the instruction caches may speed up retrieval of those instructions by processor 142. Data in the data caches may be copies of data in memory 144 or storage device 146 for instructions executing at processor 142 to operate on; the results of previous instructions executed at processor 142 for access by subsequent instructions executing at processor 142 or for writing to memory 144 or storage device 146; or other suitable data. The data caches may speed up read or write operations by processor 142. The TLBs may speed up virtual-address translation for processor 142. In particular embodiments, processor 142 may include one or more internal registers for data, instructions, or addresses. This disclosure contemplates processor 142 including any suitable number of any suitable internal registers, where appropriate. Where appropriate, processor 142 may include one or more arithmetic logic units (ALUs); be a multi-core processor; or include one or more processors 142. Although this disclosure describes and illustrates a particular processor, this disclosure contemplates any suitable processor.

In particular embodiments, memory 144 includes main memory for storing instructions such as computer program(s) 150 for processor 142 to execute, or data for processor 142 to operate on. As an example and not by way of limitation, computer system 140 may load instructions from storage device 146 or another source (e.g., another computer system 140) to memory 144. Processor 142 may then load the instructions from memory 144 to an internal register or internal cache. To execute the instructions, processor 142 may retrieve the instructions from the internal register or internal cache and decode them. During or after execution of the instructions, processor 142 may write one or more results (which may be intermediate or final results) to the internal register or internal cache. Processor 142 may then write one or more of those results to memory 144. In particular embodiments, processor 142 executes only instructions in one or more internal registers or internal caches or in memory 144 (as opposed to storage device 146 or elsewhere) and operates only on data in one or more internal registers or internal caches or in memory 144 (as opposed to storage device 146 or elsewhere). One or more memory buses (which may each include an address bus and a data bus) may couple processor 142 to memory 144. Bus 154 may include one or more memory buses, as described below. In particular embodiments, one or more memory management units (MMUs) reside between processor 142 and memory 144 and facilitate accesses to memory 144 requested by processor 142.

In certain embodiments, instructions executed by processor 142 may reside in one or more computer programs 150. Computer program 150 generally refers to instructions, logic, rules, algorithms, code, tables, or other suitable instructions for performing the described functions and operations. In some embodiments, computer program 150 may be stored in memory 144, storage device 146, or any other location accessible to computer system 140. Where appropriate, computer program 150 may include one or more computer programs 150; be unitary or distributed; span multiple locations; span multiple machines; or reside in a cloud.

In particular embodiments, storage device 146 includes mass storage for data or instructions such as computer program 150. As an example and not by way of limitation, storage device 146 may include an HDD, a floppy disk drive, flash memory, an optical disc, a magneto-optical disc, magnetic tape, a Universal Serial Bus (USB) drive, a solid-state drive (SSD), or a combination of two or more of these. Storage device 146 may include removable or non-removable (or fixed) media, where appropriate. Storage device 146 may be internal or external to computer system 140, where appropriate. In particular embodiments, storage device 146 is non-volatile, solid-state memory. In particular embodiments, storage device 146 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates storage device 146 taking any suitable physical form. Storage device 146 may include one or more storage control units facilitating communication between processor 142 and storage device 146, where appropriate. Where appropriate, storage device 146 may include one or more storage devices 146. Although this disclosure describes and illustrates particular storage, this disclosure contemplates any suitable storage.

In particular embodiments, I/O interface 148 includes hardware, software, or both providing one or more interfaces for communication between computer system 140 and one or more I/O devices. System 100 may include one or more of these I/O devices, where appropriate. One or more of these I/O devices may enable communication between a person and computer system 140. As an example and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. This disclosure contemplates any suitable I/O devices and any suitable I/O interfaces 148 for them. Where appropriate, I/O interface 148 may include one or more devices or software drivers enabling processor 142 to drive one or more of these I/O devices. I/O interface 148 may include one or more I/O interfaces 148, where appropriate. Although this disclosure describes and illustrates a particular I/O interface, this disclosure contemplates any suitable I/O interface.

In particular embodiments, communication interface 152 includes hardware, software, or both providing one or more interfaces for communication (e.g., packet-based communication and facsimile communication) between computer system 140 and one or more other computer systems 140, one or more networks such as network 120, exchange hub 130, and one or more entities 135. As an example and not by way of limitation, communication interface 152 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 152 for it. As an example and not by way of limitation, computer system 140 may communicate with an ad hoc network, a personal area network (PAN), a local area network (LAN), a wide area network (WAN), a metropolitan area network (MAN), one or more portions of the Internet, a PSTN, or a combination of two or more of these. One or more portions of one or more of these networks may be wired or wireless. As an example, computer system 140 may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. Computer system 140 may include any suitable communication interface 152 for any of these networks, where appropriate. Communication interface 152 may include one or more communication interfaces 152, where appropriate. Although this disclosure describes and illustrates a particular communication interface, this disclosure contemplates any suitable communication interface.

In particular embodiments, bus 154 includes hardware, software, or both coupling components of computer system 140 to each other. As an example and not by way of limitation, bus 154 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 154 may include one or more buses 154, where appropriate. Although this disclosure describes and illustrates a particular bus, this disclosure contemplates any suitable bus or interconnect.

Legal order 158 may be any request related to a legal matter. For example, legal order 158 may be a request from the IRS for enterprise 110 to levy funds from a particular customer's account. As another example, legal order 158 may be a request from a court related to a subpoena for information. In some embodiments, each legal order 158 is associated with either a subpoena or an attachment. In general, a subpoena may be any request for information related to a legal matter. For example, a legal order 158 associated with a subpoena may be a request for bank statements, copies of checks, deposit information, access to a safety deposit box, video surveillance, or any other appropriate information held by enterprise 110. An attachment may refer to any request related to funds such as a garnishment, a levy, a writ of attachment, or any other request related to funds held in one or more accounts at enterprise 110. Legal order 158 is generated according to standard legal order form 156. A particular embodiment of standard legal order form 156 is illustrated below in reference to FIG. 2.

FIG. 2 illustrates an example standard legal order form 156 that may be utilized by system 100 for legal order processing. In general, standard legal order form 156 is utilized by system 100 for enhanced legal order processing. Instead of receiving legal orders 158 from entities 135 that are all in different formats according to which entity 135 generated the request, system 100 or exchange hub 130 provides standard legal order form 156 to entities 135. Each entity 135 may then utilize standard legal order form 156 to generate legal orders 158. As a result, legal orders 158 processed by enterprise 110 are in a standardized format. This may allow enterprise 110 to more efficiently and accurately respond to legal orders 158.

Standard legal order form 156 may be implemented in any appropriate technology including, but not limited to, XML, SAS, SMS, or any other appropriate technology. Standard legal order form 156 includes various fields, including some fields which may be required fields (e.g., fields that must be populated in order for legal order 158 to be processed). Standard legal order form 156 may also include repeatable data structures. For example, standard legal order form 156 may include fields for customer information and account numbers which may be repeated multiple times according to the number of customers associated with legal order 158.

In the illustrated embodiment, standard legal order form 156 includes a request type field 210, an issuing entity field 215, contact information field 220, case ID field 225, case name field 230, appearance required field 235, amount field 240, expiration date field 245, one or more customer information fields 250, and one or more account number fields 255. In some embodiments, standard legal order form 156 may include more or fewer fields than illustrated in FIG. 2. In addition, while fields 210-255 of standard legal order form 156 are illustrated in FIG. 2 in a particular order, it should be understood that standard legal order form 156 may have any appropriate layout or appearance.

Request type field 210 indicates the type of legal order 158. For example, request type field 210 may include “attachment” to indicate that the legal order 158 is an attachment legal order. As another example, request type field 210 may include “subpoena” to indicate that the legal order 158 is a subpoena legal order. Request type field 210 may include any other appropriate type of legal order including, but not limited to, “levy,”, “garnishment,”, “writ of attachment,” and the like.

Issuing entity field 215 indicates the entity 135 that generated the legal order 158. For example, issuing entity field 215 may include “Internal Revenue Service.” Contact information field 220 indicates a name of a person associated with the entity 135 that generated the legal order 158. For example, contact information field 220 may indicate the name of the investigator, case worker, or any other person within the entity 135 that generated the legal order 158.

Case ID field 225 indicates an identification of a court case associated with legal order 158. Case name field 230 indicates a name of a court case associated with legal order 158. As a particular example, if legal order 158 is associated with a court case entitled “Party A v. Party B” that has a case identification number of 12345ABC, case ID field 225 may include “12345ABC” and case name field 230 may include “Party A v. Party B.”

Appearance required field 235 indicates whether an individual is required to appear at a particular court hearing or deposition. Amount field 240 indicates an amount associated with an attachment. For example, if legal order 158 is requesting a garnishment of a certain amount of money, this amount of money will be included in amount field 240. Expiration date field 245 indicates a particular date that the legal order 158 expires.

Standard legal order form 156 includes one or more customer information fields 250. Each customer information field 250 includes various information about a particular customer associated with the legal order 158. This information may include a customer tax ID, a customer type (i.e., business or personal), a business name, a name prefix, a first name, a middle name, a last name, a name suffix, a mailing address, a date of birth, and the like. Standard legal order form 156 may also include an account number field 255 for each customer information field 250. Account number field 255 indicates an account number of an account held by customer at enterprise 110.

While the illustrated embodiment of standard legal order form 156 illustrates customer information fields 250 and account number field 255 as including only a single field, it should be understood that these fields may include additional fields as needed. For example, customer information field 250 may include required fields such as name, address, date of birth, tax ID, and the like. In addition, this disclosure is not limited to the arrangement, type, or number of fields illustrated in FIG. 2. For example, some embodiments may include other fields not illustrated in FIG. 2. These fields may include, but are not limited to, a due date field, a disclosure type field (i.e., disclosure or non-disclosure), a document type requested field (i.e., statements, checks, deposits, wires, ACH, video surveillance, applications, signature cards, etc.), a document format field (i.e., xml, csv, tif, etc.), an action code field, a withhold date field, a payment information field (i.e., a field for ACH/EFT information for payments), a special instructions field (i.e., a free-form field for seizure warrants, grand jury, hold requirements, etc.), and the like. In some embodiments, standard legal order form 156 may include the ability to transmit images of documents to/from enterprise 110 (i.e., images of original legal order, subpoena documents, etc.).

In some embodiments, standard legal order form 156 is a format that is acceptable and/or approved by entities 135 such as courts. For example, if a subpoena legal order 158 is received by enterprise 110 from a court, enterprise 110 could be assured that the release of information associated with the subpoena legal order 158 was authorized by the court. As another example, if an attachment legal order 158 is received by enterprise 110 from a state court, enterprise 110 could be assured that the attachment conforms to appropriate state statutes.

Returning to FIG. 1, legal order response 172 may include any appropriate response to legal order 158. For example, if legal order 158 is associated with a levy of a customer's account, legal order response 172 may include an invoice and/or electronic routing information associated with fees for levying the account. As another example, if legal order 158 is associated with a subpoena for certain documents, legal order response 172 may include the requested documents. In some embodiments, legal order response 172 may be in a standardized format. This standardized format may control what information is presented in each legal order response 172 from enterprise 110 and thus allow entities 135 to more quickly and efficiently receive and process responses to legal order 158.

In operation, one or more computer systems 140 of enterprise 110 provide processing of legal orders 158 that were originated by one or more entities 135 using standard legal order form 156. In some embodiments, entities 135 transmit one or more legal orders 158 directly to system 100. In other embodiments, exchange hub 130 is utilized by system 100 to collect legal orders 158 from entities 135. In embodiments where exchange hub 130 is utilized, entity 135 first utilizes client 115 to transmit one or more legal orders 158 to exchange hub 130 where they are stored in memory 134. Each legal order 158 is generated according to a standard legal order form 156. Standard legal order form 156 is provided to entity 135 by exchange hub 130 or enterprise 110.

In some embodiments, entity 135 may utilize standard legal order form 156 to generate multiple legal orders 158 which are transmitted to exchange hub 130 in bulk. For example, entity 135 may receive standard legal order form 156, generate multiple legal orders 158 according to the standard legal order form 156, and then transmit the generated legal orders 158 to exchange hub 130. In other embodiments, entity 135 may view a graphical representation of standard legal order form 156 on GUI 165 of client 115, enter data into GUI 165 to create a single legal order 158, and transmit the completed legal order 158 to exchange hub 130.

After receiving one or more legal orders 158 from entity 135, legal orders 158 stored in memory 134 of exchange hub 130 may be transmitted to computer system 140 using either a push or pull transmission technique. For example, a pull technique may be utilized in which computer system 140 periodically requests legal orders 158 from exchange hub 130. In another example, a push technique may be utilized in which exchange hub 130 periodically transmits legal orders 158 to computer system 140.

Computer system 140 may store legal orders 158 received from exchange hub 130 or entity 135 in memory 144. Computer system 140 may then access legal orders 158 and process the legal orders 158 according to information in the legal orders 158. For example, computer system 140 may first determine a category of the particular legal order from one or more known categories. The categories may include, for example, a subpoena for information and an attachment associated with an amount of funds. In some embodiments, the category of legal order 158 may be determined by analyzing fields such as request type field 210 and/or amount filed 240. For example, one embodiment may determine that a particular legal order 158 is an attachment legal order if amount field 240 includes an amount of money. As another example, a particular legal order 158 may be determined to be a subpoena if appearance required field 235 is populated.

After the category of legal order 158 has been determined, computer system 140 processes legal order 158 according to the determined category. For example, if the legal order 158 is determined to be associated with a subpoena for information, computer system 140 may first identify one or more documents responsive to the subpoena for information. In certain embodiments, the identified documents may include account statements or images of checks of a particular customer identified in customer information field 250. The identified documents may then be stored in memory such as memory 144 or any other appropriate storage device. Computer system 140 may then generate a legal order response 172 that indicates which documents were identified. In some embodiments, the identified documents may be digitally attached to legal order response 172. The generated legal order response 172 may be transmitted either directly to the appropriate entity 135 or to exchange hub 130 where it may be stored and transmitted to entity 135 at a later time. Exchange hub 130 may also store any images, documents, or data associated with legal order response 172 and transmit the stored data to entity 135.

In embodiments where a legal order 158 is determined to be associated with an attachment, computer system 140 may first verify a customer account of the particular legal order 158. In some embodiments, this may include determining an account number from account number field 255 and accessing a database of customer accounts. Computer system 140 may then transfer at least a portion of the amount of funds indicated in amount field 240 from the customer account. In some embodiments, this may include transferring the funds to a holding account where the funds are held for a certain amount of time (i.e., twenty-one days). Computer system 140 may then generate a legal order response 172 that indicates the attachment was processed. The generated legal order response 172 may be transmitted either directly to the appropriate entity 135 or to exchange hub 130 where it may be stored and transmitted to entity 135 at a later time.

In some embodiments, computer system 140 may communicate with entities 135 and/or customers during the processing of legal orders 158. For example, computer system 140 may send a notification to a customer that it is processing a legal order 158 to levy funds from the customer's account. The notifications may be communicated in any appropriate technique including, but not limited to, e-mail, text messaging, and the like.

In some embodiments, computer system 140 may generate an invoice associated with legal order 158. For example, computer system 140 may assess a fee for levying funds from a customer's account. In some embodiments, the invoice may include the amount of the fee and electronic routing information associated with payment of the fee. In certain embodiments, the invoice may be included in or electronically attached to legal order response 172. In some embodiments, exchange hub 130 may store the invoice and/or payment information and make it available to entities 135.

In some embodiments, legal orders 158 are authenticated prior to being processed by computer system 140. The authentication may be performed by either exchange hub 130 or computer system 140. For example, a legal order 158 may be analyzed to determine whether it was served properly. This may include determining whether the legal order 158 was signed properly, whether it was stamped properly by the court, whether it was served in an appropriate manner, and the like. In some embodiments, a list of authenticated sources may be stored in exchange hub 130 or computer system 140. For example, exchange hub 130 may store a list of known entities in memory 134. This list may include, for example, specific IP addresses of authorized entities 135. Exchange hub 130 may then compare the IP address of an entity 135 that has transmitted a legal order 158 to the list. If the IP address matches an IP address in the list, exchange hub 130 may determine that the legal order 158 is from a known source and is therefore an authenticated legal order 158. If, however, a legal order 158 is not authenticated, exchange hub 130 may prevent the legal order 158 from being transmitted to computer system 140.

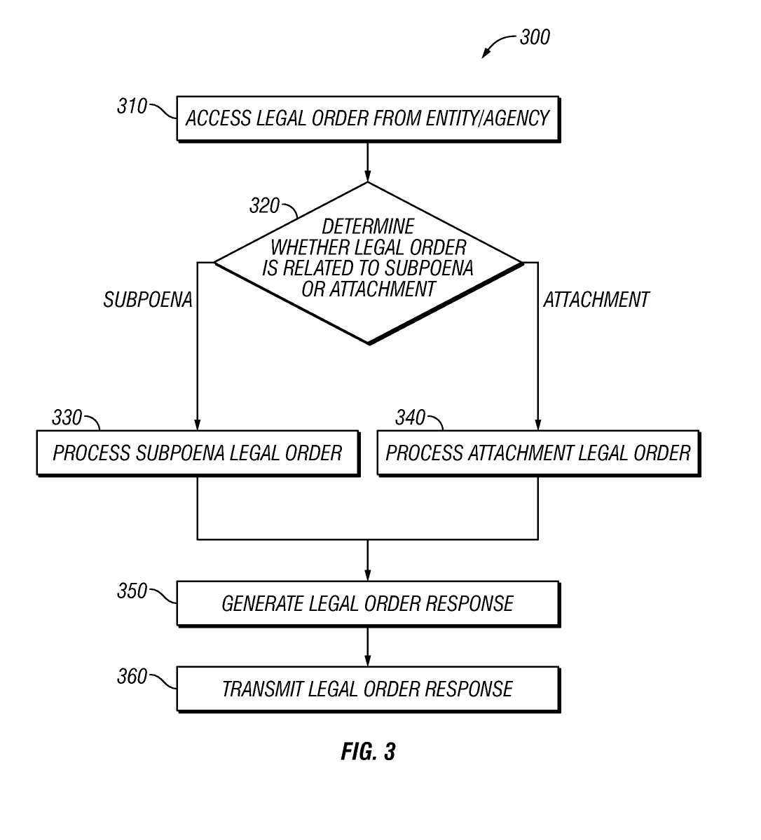

FIG. 3 illustrates one embodiment of a method 300 for providing legal order processing. Method 300 may be implemented, for example, by one or more computer programs 150 in computer system 140. Method 300 begins in step 310 where a legal order is accessed. In some embodiments, the legal order refers to legal order 158 discussed above. In some embodiments, the legal order was generated by an entity such as entity 135. In certain embodiments, the legal order is in a standardized format according to standard legal order form 156. In some embodiments, the legal order was received from an external exchange hub, such as exchange hub 130 described above, using a push or pull communications technique.

In step 320, it is determined whether the legal order accessed in step 310 is related to a subpoena or an attachment. If it is determined that the legal order is related to a subpoena, method 300 proceeds to step 330. If it is determined that the legal order is related to an attachment, method 300 proceeds to step 340. In some embodiments, information in the legal order of step 310 is utilized to determine whether the legal order is related to a subpoena or an attachment. For example, data in request type field 210, issuing entity field 215, amount field 240, appearance required field 235, or any other field of standard legal order form 156 is analyzed in determining whether the legal order is related to a subpoena or an attachment.

In step 330, the subpoena legal order accessed in step 310 is processed. In some embodiments, step 330 includes identifying one or more documents responsive to the subpoena, storing the one or more identified documents, and determining whether payment is required for the processing. In some embodiments, step 330 includes sending a notification to the entity that generated the legal order and/or a customer.

In step 340, the attachment legal order accessed in step 310 is processed. In some embodiments, step 340 includes verifying a customer account of the particular legal order, transferring at least a portion of the amount of funds from the customer account to a holding account, and generating an invoice associated with the legal order. In some embodiments, step 340 includes sending a notification to the entity that generated the legal order and/or a customer.

In step 350, a legal order response is generated. In some embodiments, the legal order response of step 350 refers to legal order response 172 discussed above. In some embodiments, the legal order response generated in step 350 is in a standardized format. In certain embodiments, the generated legal order response includes the invoice generated in steps 330 or 340. In some embodiments, the generated legal order response includes images, documents, or any other appropriate data responsive to the processed legal order.

In step 360, the legal order response generated in step 350 is transmitted to the entity that originally generated the legal order accessed in step 310. In some embodiments, the legal order response is transmitted directly to the entity. In some embodiments, the legal order response is transmitted to an exchange hub which transmits the legal order response to the entity. After step 360, method 300 ends.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, capable, configured, enabled, operable, or operative.

What is claimed is:

1. A system, comprising:
a memory operable to store a plurality of legal orders, each legal order associated with a request by an entity submitted using a standardized legal order form; and
a processor communicatively coupled to the memory and operable to:
access a particular legal order stored in the memory;
determine, from a plurality of categories, a category of the particular legal order, the plurality of categories comprising:
a subpoena for information; and
an attachment associated with an amount of funds;
process, based on the determined category, the particular legal order; and
transmit, based on the processing, a legal order response for receipt by the entity.

2. The system of claim 1, wherein:
the plurality of legal orders are received by the system from an exchange hub, the exchange hub being external to the system; and
the legal order response is transmitted to the entity via the exchange hub.

3. The system of claim 2, wherein the plurality of legal orders are received from the exchange hub using a push technique.

4. The system of claim 2, wherein the plurality of legal orders are received from the exchange hub using a pull technique.

5. The system of claim 1, wherein:
the particular legal order is determined to comprise a subpoena for information;
processing the particular legal order comprises:
identifying one or more documents responsive to the subpoena;
storing the one or more identified documents; and
determining whether payment is required for the processing; and
the legal order response comprises the one or more documents and instructions regarding any determined payment for the processing.

6. The system of claim 1, wherein:
the particular legal order is determined to comprise an attachment associated with an amount of funds;
processing the particular legal order comprises:
verifying a customer account of the particular legal order;
transferring at least a portion of the amount of funds from the customer account to a holding account; and
generating an invoice associated with the legal order; and
the legal order response comprises the invoice.

7. The system of claim 1, wherein the standardized legal order form comprises:
a request type field;
an identification of the requesting entity field;
a case identification field; and
a customer identification field.

8. The system of claim 1, wherein the attachment associated with an amount of funds comprises a selected one of:
a garnishment;
a levy; and
a writ of attachment.

9. A method comprising:
accessing, by a computer system from a plurality of legal orders stored in memory, a particular legal order, each legal order associated with a request by an entity submitted using a standardized legal order form;
determining, by the computer system from a plurality of categories, a category of the particular legal order, the plurality of categories comprising:
a subpoena for information; and
an attachment associated with an amount of funds;
processing, by the computer system based on the determined category, the particular legal order; and
transmitting, by the computer system based on the processing, a legal order response for receipt by the entity.

10. The method of claim 9, wherein:
the plurality of legal orders are received by the system from an exchange hub, the exchange hub being external to the system; and
the legal order response is transmitted to the entity via the exchange hub.

11. The method of claim 10, wherein the plurality of legal orders are received from the exchange hub using a push or a pull technique.

12. The method of claim 9, wherein:
the particular legal order is determined to comprise a subpoena for information;
processing the particular legal order comprises:
identifying one or more documents responsive to the subpoena;
storing the one or more identified documents; and
determining whether payment is required for the processing; and
the legal order response comprises the one or more documents and instructions regarding any determined payment for the processing.

13. The method of claim 9, wherein:
the particular legal order is determined to comprise an attachment associated with an amount of funds;
processing the particular legal order comprises:
verifying a customer account of the particular legal order;
transferring at least a portion of the amount of funds from the customer account to a holding account; and
generating an invoice associated with the legal order; and
the legal order response comprises the invoice.

14. The method of claim 9, wherein the standardized legal order form comprises:
a request type field;
an identification of the requesting entity field;
a case identification field; and
a customer identification field.

15. One or more computer-readable non-transitory storage media embodying software this is operable when executed by one or more computer systems to:
access a particular legal order from a plurality of legal orders, each legal order associated with a request by an entity submitted using a standardized legal order form;
determine, from a plurality of categories, a category of the particular legal order, the plurality of categories comprising:
a subpoena for information; and
an attachment associated with an amount of funds;
process, based on the determined category, the particular legal order; and
transmit, based on the processing, a legal order response for receipt by the entity.

16. The media of claim 15, wherein:
the plurality of legal orders are received by the system from an exchange hub, the exchange hub being external to the system; and
the legal order response is transmitted to the entity via the exchange hub.

17. The media of claim 16, wherein the plurality of legal orders are received from the exchange hub using a push or a pull technique.

18. The media of claim 15, wherein:
the particular legal order is determined to comprise a subpoena for information;
processing the particular legal order comprises:
identifying one or more documents responsive to the subpoena;
storing the one or more identified documents; and
determining whether payment is required for the processing; and
the legal order response comprises the one or more documents and instructions regarding any determined payment for the processing.

19. The media of claim 15, wherein:
the particular legal order is determined to comprise an attachment associated with an amount of funds;
processing the particular legal order comprises:
verifying a customer account of the particular legal order;
transferring at least a portion of the amount of funds from the customer account to a holding account; and
generating an invoice associated with the legal order; and
the legal order response comprises the invoice.

20. The media of claim 15, wherein the standardized legal order form comprises:
a request type field;
an identification of the requesting entity field;
a case identification field; and
a customer identification field.
